(19) United States
(12) Patent Application Publication
(10) Pub. No.: US 2024/0256953 A1
(43) Pub. Date: Aug. 1, 2024

(54) ARTIFICIAL INTELLIGENCE ASSISTED CONFLICT SCENARIO DETECTION WITH ADDITION OF CLASSES

(71) Applicant: Volvo Car Corporation, Göteborg (SE)

(72) Inventors: Tomas Björklund, Gothenburg (SE); Ashok Krishna Chaitanya Koppisetty, Gothenburg (SE); Erik Hjerpe, Gothenburg (SE)

(21) Appl. No.: 18/161,464

(22) Filed: Jan. 30, 2023

(51) Int. Cl. G06N 20/00; G08G 1/16

(52) U.S. Cl. CPC G06N 20/00; G08G 1/163

(57) ABSTRACT

One or more systems, devices, computer program products and/or computer-implemented methods of use provided herein relate to using an AI model to detect conflict scenarios for vehicles. The computer-implemented system can comprise a memory that can store computer executable components. The computer-implemented system can further comprise a processor that can execute the computer executable components stored in the memory, wherein the computer executable components can comprise a first AI model that can process signal data from a vehicle to detect at least one or more near-collision scenarios, such that data from the at least one or more near-collision scenarios can be used to train a second AI model to define one or more rules that can enable the second AI model to detect one or more new near-collision scenarios with a level of accuracy above that of the first AI model.

### TECHNICAL FIELD

The subject disclosure relates to artificial intelligence (AI) and, more specifically, to AI assisted conflict scenario detection with addition of classes.

### BACKGROUND

A vehicular collision can involve one or more vehicles colliding with each other or with any suitable stationary or non-stationary objects. During normal operations of a vehicle, the vehicle can be involved in several situations that can lead to a vehicular collision under detrimental circumstances.

The above-described background relating to vehicular collisions is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable AI assisted conflict detection with addition of classes are discussed.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a detection component that can process signal data generated by a vehicle to detect at least one or more non-collision scenarios. The computer executable components can further comprise a first artificial intelligence model (AI model) that can process the signal data to detect at least one or more near-collision scenarios, such that data from the at least one or more near-collision scenarios can be used to train a second AI model to define one or more rules that can enable the second AI model to detect one or more new near-collision scenarios with a level of accuracy above that of the first AI model.

In an embodiment, the signal data comprising the at least one or more near-collision scenarios can form outlier data previously unseen by the first AI model, wherein the outlier data can be annotated to generate annotated data for training of the second AI model. In another embodiment, the annotated data can be used as a new class of data to generate training data, validation data, and test data for the training, validation and testing of the second AI model.

According to another embodiment, a computer-implemented method is provided. The computer-implemented method can comprise processing, by a system operatively coupled to a processor, signal data generated by a vehicle to detect at least one or more non-collision scenarios. The computer-implemented method can further comprise processing, by the system, the signal data to detect at least one or more near-collision scenarios, such that data from the at least one or more near-collision scenarios can be used to train a second AI model to define one or more rules that can enable the second AI model to detect one or more new near-collision scenarios with a level of accuracy above that of a first AI model.

In an embodiment, the second AI model can combine two or more signals from the signal data to define the one or more rules.

According to yet another embodiment, a computer program product for using an AI model to detect conflict scenarios for vehicles is provided. The computer program product can comprise a computer readable storage medium having program instructions embodied therewith, the program instructions executable by a processor to cause the process, by the processor, signal data generated by a vehicle to detect at least one or more non-collision scenarios. The program instructions can be further executable by the processor to cause the processor to process, by the processor, the signal data to detect at least one or more near-collision scenarios, such that data from the at least one or more near-collision scenarios can be used to train a second AI model to define one or more rules that can enable the second AI model to detect one or more new near-collision scenarios with a level of accuracy above that of a first AI model.

In an embodiment, the program instructions can be further executable by the processor to cause the processor to collect, by the processor, the signal data from one or more sensors of the vehicle, wherein the signal data comprising the at least one or more near-collision scenarios can form inlier data required for training the second AI model. In another embodiment, the program instructions can be further executable by the processor to cause the processor to analyze, by the processor, the inlier data to identify, from the inlier data, one or more classes of data required for the training of the second AI model, wherein the one or more classes of data can be annotated to generate annotated data for the training of the second AI model.

An advantage of the device, system, computer-implemented method and/or computer program product discussed above can be improving an ability of an AI model to detect risk/near-collision scenarios from a vehicle's signal data. That is, the AI model can detect near-collision scenarios such that a vehicle associated with the AI model can intervene (e.g., by braking) upon detection of the near-collision scenarios to prevent a collision.

Another advantage of the device, system, computer-implemented method and/or computer program product discussed above can be enabling the AI model associated with the vehicle to define more accurate rules to detect the risk/near-collision scenarios. The AI model can combine different signals from the vehicle's signal data in extremely complex ways to define the more accurate rules.

Yet another advantage of the device, system, computer-implemented method and/or computer program product discussed above can be enabling the AI model to propose new risk/near-collision scenarios during ongoing data collection and/or deployment. That is, the AI model can detect risk/near-collision scenarios previously unknown to the AI model, during normal operations of a vehicle.

### BRIEF DESCRIPTION OF THE DRAWINGS

FIG. 1 illustrates a block diagram of an example, non-limiting system that enables an AI model to detect new and existing classes of conflict scenarios for vehicles in accordance with one or more embodiments described herein.

FIG. 2 illustrates a flow diagram of an example, non-limiting system that enables training an AI model to detect new classes of conflict scenarios in accordance with one or more embodiments described herein.

FIG. 3 illustrates a flow diagram of an example, non-limiting system that enables training an AI model to detect new classes of conflict scenarios in accordance with one or more embodiments described herein.

FIG. 4 illustrates a flow diagram of an example, non-limiting method that enables an AI model to detect new and existing classes of conflict scenarios for vehicles in accordance with one or more embodiments described herein.

FIG. 5 illustrates a flow diagram of an example, non-limiting method that enables training an AI model to detect new classes of conflict scenarios for vehicles in accordance with one or more embodiments described herein.

FIG. 6 depicts an example schematic block diagram of a computing environment with which the disclosed subject matter can interact/be implemented at least in part, in accordance with various aspects and implementations of the subject disclosure.

FIG. 7 is a block diagram representing an example computing environment into which aspects of the subject matter described herein may be incorporated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Conflict situations (e.g., near-collision scenarios) involving vehicles in the real world can occur without knowledge of an imminent risk of a collision. Such situations or scenarios can entail details on root causes of possible collisions and information on how to address and mitigate risks of the possible collisions. In many situations, a crash does not occur, even if the crash could have occurred under unfortunate circumstances. Thus, such situations can be difficult to identify as risky situations (e.g., near-collision scenarios) and separate from risk free situations (e.g., non-collision scenarios). Often, potential conflict scenarios (e.g., near-collision scenarios) can be manually defined in an engineering development process from previously existing knowledge or by using predefined rules around known parameters. The predefined rules can be based on physical and kinetic properties of vehicles and vehicular surroundings, and the predefined rules can be further refined with simulation data. Further, since large amounts of data can be collected in relation to a vehicle, manual identification of potential conflict situations (e.g., near-collision scenarios) can be laborious, and defining rules by hand for the potential conflict situations can be very crude and/or subjective. Accordingly, the one or more embodiments discussed herein with reference to the subject disclosure can enable an AI model to suggest new, previously unconsidered conflict situations (e.g., near-collision scenarios) for vehicles. It is to be appreciated that in the one or more embodiments discussed throughout this specification, near-conflict or near-collision scenarios can imply potentially dangerous vehicular situations that can lead to a collision under unfortunate circumstances, but that can go unnoticed otherwise. Similarly, non-conflict or non-collision scenarios can imply vehicular situations that are not potentially dangerous.

The subject disclosure is directed to computer processing systems, computer-implemented methods, apparatus and/or computer program products that can enable an AI-based methodology for identifying risky or near-collision scenarios from a car's signal data. The proposed computer processing systems, computer-implemented methods, apparatus and/or computer program products can enable a system to identify abnormalities in a chosen signal data and suggest an initial population of scenarios that can be near-collisions scenarios. The near-collision scenarios can be further validated by a human expert and fed back to the system, thus enriching the learning of the system. Using AI (e.g., an AI model), exact rules need not be defined for different signals to generate a definition of potential near-collision scenarios. Rather, the AI can combine different signals in extremely complex ways to define more accurate rules, and the approach discussed herein can allow the AI to propose new scenarios, based on the more accurate rules, during ongoing data collection and/or deployment of the AI in vehicles (e.g., a fleet of vehicles, a vehicle model, etc.). If the proposed abnormalities (e.g., near-collision scenarios) do not match any previously identified categories of near-collision scenarios, the proposed abnormalities can be collected as one or more new categories of the near-collision scenarios for training the system to learn to identify.

In one or more embodiments, data collected in a vehicle can be processed by an unsupervised anomaly detector as well as a current version of an AI model. The unsupervised anomaly detector can be trained to recognize common data (e.g., non-collision scenarios), that is, data not comprising a conflict situation (e.g., near-collision scenarios, collision scenarios), and the AI model (current version) can be trained to identify specific conflict situations (e.g., near-collision scenarios, collision scenarios). When the unsupervised anomaly detector does not recognize incoming data as common data, and the AI does not identify the incoming data as a conflict situation, the incoming data can be determined to be an outlier, otherwise the incoming data can be determined to be an inlier. Outlier data can become proposed training samples and sent to a user (annotator) for annotation. Inlier data can be sent to a sample balancer that can determine whether data of a specific/desired class (e.g., a specific category of conflict scenario) is needed for training the AI model. If the data is needed for training the AI model, the data can be sent to the user (annotator) for annotation. The annotated data of existing trained classes can be sent to labelled ground truth samples (e.g., existing class of data 210) for training, validation and testing for the AI model where the annotated data can be sorted into training, validation or test sets. The process of sorting the annotated data is not necessarily automatic but can also be determined in batches by an AI engineer.

Similarly, annotated data from new classes of scenarios comprised in the outlier data can be sent to ground truth classified samples of new classes where the annotated data from the new classes of scenarios can be stockpiled until the AI engineer determines that there is enough data to start including the new classes of scenarios to the AI model. The annotated data from the new classes of scenarios can be sorted into training, validation, or test sets, as before. The AI model can be trained on the annotated data from the new classes of scenarios to generate a new AI model, and if the results are promising, the new AI model can replace the AI model. Thus, one or more embodiments discussed herein can enable an AI model that can learn over time in cooperation with a supervisor (e.g., user or annotator) to improve as more data is collected, as opposed to simply using AI on a labelled dataset. Furthermore, the AI model can gather data of new and previously unforeseen scenarios, enhancing the AI model not only by becoming more accurate for an initial intended use, but also by extending the AI model to include new scenarios.

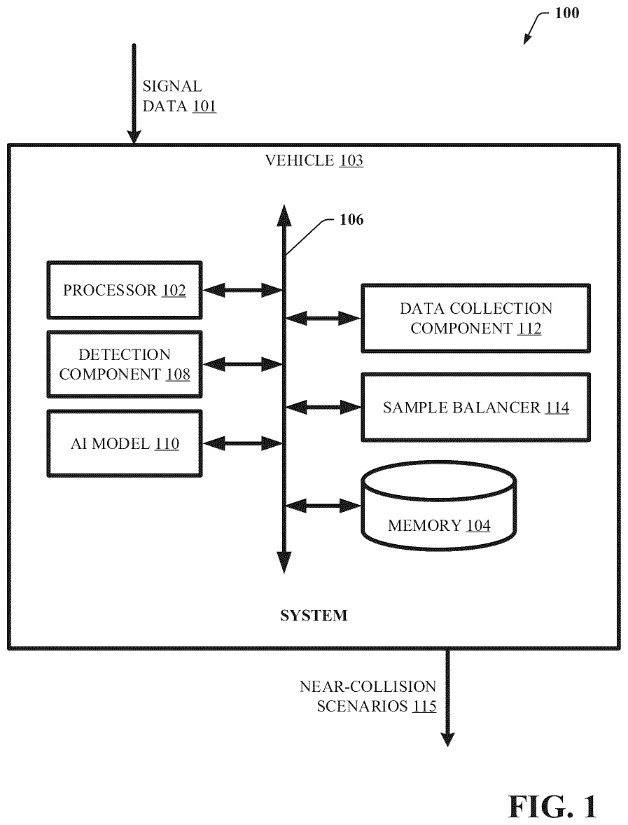

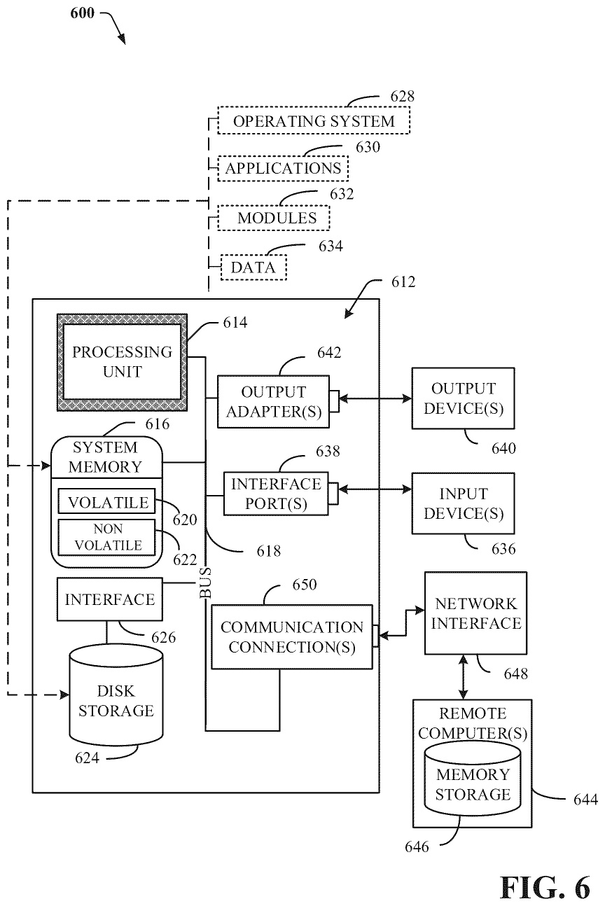

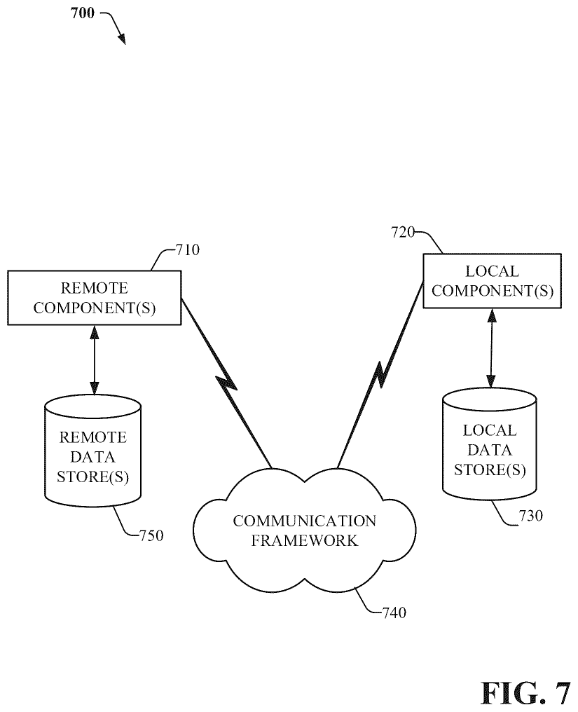

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to a computing environment, such as the computing environments 600 and 700 respectively illustrated at FIGS. 6 and 7. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that enables an AI model to detect new and existing classes of conflict scenarios for vehicles in accordance with one or more embodiments described herein. System 100 can comprise processor 102, memory 104, system bus 106, detection component 108, AI model 110, data collection component 112 and sample balancer 114.

During normal operations, a vehicle (e.g., autonomous car/vehicle, other type of car/vehicle, etc.) can perform unsupervised recording of data comprising regular/everyday traffic situations, and the vehicle can perform an automatic system intervention when a collision or crash (e.g., conflict situation) occurs. For example, a vehicle's automatic safety emergency braking system can intervene during a collision scenario as opposed to before a collision scenario. In the event of such an automatic system intervention, a log comprising information about the collision can be generated, and the vehicle can generate a notification about the log. The log can then be identified and used as a sample to train an existing AI in the vehicle such that the existing AI can exhibit a better performance in the event of a future collision.

However, in the absence of such an automatic system intervention, the vehicle does not generate a notification, and information about near-collision scenarios that can be recorded by the vehicle as part of the unsupervised recording of data comprising the regular/everyday traffic situations can be missed. Such information can be used for training the existing AI to detect a potential conflict scenario in the future. Thus, some of the data recorded by the vehicle during the normal operations can be background data comprising information about potentially risky collision scenarios (e.g., near-collision scenarios) that can lead to a collision without critical intervention from the vehicle and/or an operator of the vehicle before the collision occurs. In other words, even in the absence of a collision, the vehicle can be recording information about the potentially risky collision scenarios.

Such data can be difficult to identify and separate (e.g., via statistical methods) from the background data comprising information about non-collision scenarios without predefined knowledge of the specific types of collision scenarios. For example, a vehicle can be unable to identify a new type of road sign introduced by a city, and while the vehicle can record the new type of road sign as background data, it can not generate a notification about the new type of road sign. Thus, an AI engineer can analyze the data recorded by the vehicle without learning about the existence of the new type of road sign, and AI-based safety systems and functions in the vehicle can be retrained without accounting for the new type of road sign. Such a situation can lead to a collision scenario during future operations of the vehicle, for example, if the new type of road sign is a stop signal and the vehicle fails to come to a complete halt upon encountering the new type of road sign.

While it can be challenging to employ human persons (e.g., user or annotator) to annotate hundreds of thousands of hours of data recorded by the vehicle during normal operations, it can be beneficial to sift a few scenarios to perform manual annotation on a smaller subset of the data by discarding a large bulk of the data comprising normal situations (e.g., non-conflict or non-collision scenarios). Generally, the safety systems and functions in a vehicle can be based on predefined rules wherein the safety systems and functions of the vehicle can be designed to handle specific scenarios (e.g., collision scenarios). The predefined rules can be based on physical and kinematic properties of the vehicle (e.g., physical models) to identify potential collision scenarios. Thus, the data recorded by the vehicle during normal operations can be analyzed such that near-collision scenarios that can exist outside of the potential collision scenarios based on the predefined rules can be detected from signal data of the vehicle. Such scenarios can be used to enhance the safety systems and functions in the vehicle.

Accordingly, system 100 and/or components of system 100 can enable AI assisted identification of edge cases for refining or developing occupant safety functions for an automotive vehicle. For example, system 100 can enable detection of new data comprising an existing class of data. For example, the new data can comprise data related to collisions with moose or deer, wherein the collisions with the moose or the deer can be grouped into an existing class of collisions (e.g., collisions involving animals) for training the AI model (e.g., AI model 110, AI model 220). For example, system 100 can enable detection of new data comprising a new class of data. For example, the new data can comprise collisions due to a new type of traffic light, wherein the collisions due to the new type of traffic light can be grouped into a new class of collisions and cannot be grouped into existing classes of collisions.

The system 100 and/or the components of the system 100 can be employed to use hardware and/or software to solve problems that are highly technical in nature (e.g., related to AI, detecting near-collision scenarios for vehicles, etc.), that are not abstract and that cannot be performed as a set of mental acts by a human. Further, some of the processes performed may be performed by specialized computers for carrying out defined tasks related to the AI application/subject area. The system 100 and/or components of the system can be employed to solve new problems that arise through advancements in technology, road/driving conditions, environmental scenarios and the like. The system 100 can provide technical improvements to artificially intelligent (AI) systems by improving an ability of an AI model to detect risk/near-collision scenarios from a vehicle's signal data, enabling the AI model to define more accurate rules to detect the risk/near-collision scenarios, and/or enabling the AI model to propose new risk/near-collision scenarios during ongoing data collection and/or deployment, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., detection component 108, AI model 110, data collection component 112 and/or sample balancer 114) to perform one or more actions. In one or more embodiments, memory 104 can store computer-executable components (e.g., detection component 108, AI model 110, data collection component 112 and/or sample balancer 114).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). System 100 can be associated with, such as accessible via, a computing environment 600 described below with reference to FIG. 6. For example, system 100 can be associated with a computing environment 600 such that aspects of processing can be distributed between system 100 and the computing environment 600.

In one or more embodiments, vehicle 103 can comprise data collection component 112, wherein data collection component 112 can collect signal data 101 from one or more sensors of vehicle 103. Some data useful data for classification can come from sources other than the one or more sensors of vehicle 103 (e.g., road map information, weather data, etc.). Signal data 101 can comprise time series of vehicle locations, speed and other status signals, and inward and outward facing video. Signal data 101 can further comprise radio inputs, speed inputs, break inputs, steering inputs and/or other types of signal inputs from a driver or operator of vehicle 103, and the one or more sensors can comprise position sensors, speed and velocity sensors, inertial sensors, pressure sensors, etc. Signal data 101 can represent information about various scenarios encountered by vehicle 103 during normal operations of vehicle 103, wherein the various scenarios can comprise non-collision scenarios (e.g., braking at a red light or a stop sign), near-collision scenarios familiar to vehicle 103 (e.g., braking upon suddenly detecting an animal) and/or near-collision scenarios unfamiliar to vehicle 103 (e.g., a new type of rail road).

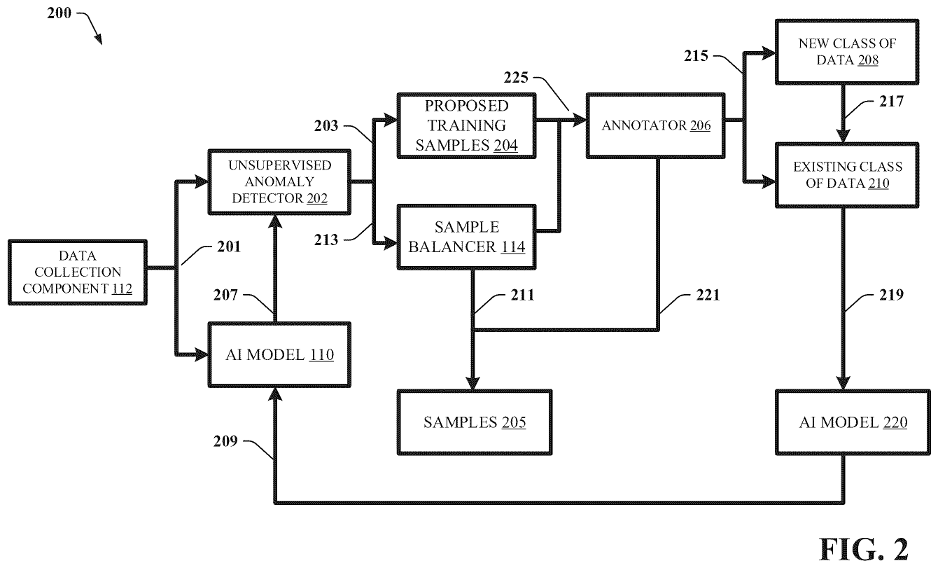

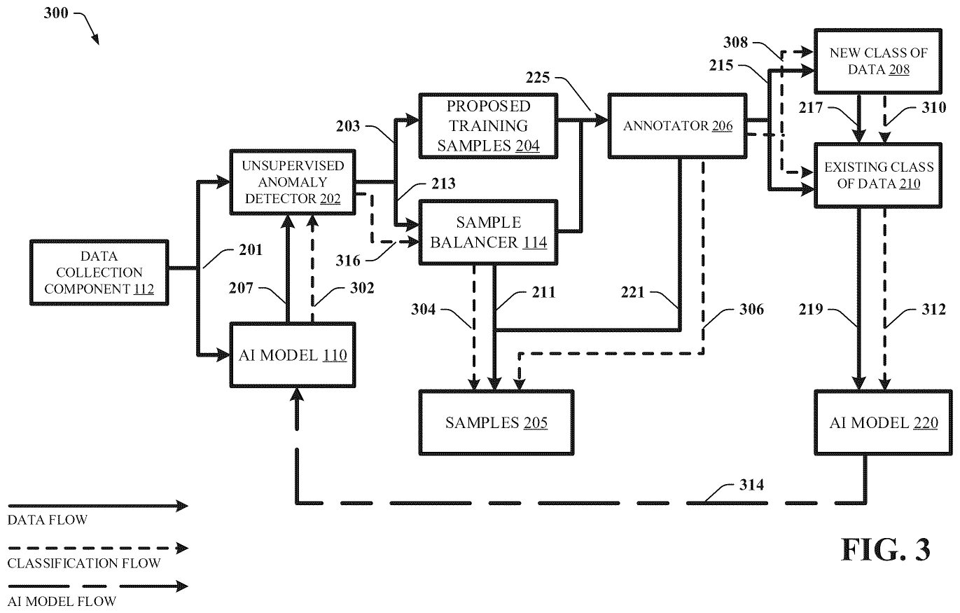

Detection component 108 can process signal data 101 generated by vehicle 103 to detect at least one or more non-collision scenarios (non-near collision scenarios), and a first AI model (e.g., AI model 110) can process the signal data to detect at least one or more near-collision scenarios, such that data from the at least one or more near-collision scenarios can be used to train a second AI model (e.g., AI model 220 of FIGS. 2 and 3) to define one or more rules that can enable the second AI model to detect one or more new near-collision scenarios with a level of accuracy above that of the first AI model. For example, AI model 220 can be trained using at least the one or more near-collision scenarios such that AI model 220 can detect one or more new near-collision scenarios (e.g., near-collision scenarios 115) more accurately than AI model 110. The second AI model (e.g., AI model 220) can combine two or more signals from signal data 101 to define the one or more rules. In one or more embodiments, detection component 108 can be an unsupervised anomaly detector, wherein an unsupervised anomaly detector can be an algorithm trained to detect an anomaly in received input data.

Signal data 101 comprising the at least one or more near-collision scenarios (e.g., near-collision scenarios familiar to AI model 110) can form inlier data required for training the second AI model (e.g., AI model 220). Sample balancer 114 can analyze the inlier data to identify, from the inlier data, one or more classes of data required for training the second AI model (e.g., AI model 220), wherein the one or more classes of data can be annotated to generate annotated data for training the second AI model. The annotated data can be used as an existing class of data to generate training data, validation data, and test data for training, validation and testing of the second AI model (AI model 220). It is to be appreciated that the three steps (e.g., training, validation, testing) can be mixed up in different steps of a training process (e.g., training an AI model). That is, while in many cases, test data can be generally used for testing (e.g., testing the AI model), it is not necessary that training data can be used only during training, validation data can be used only during a separate validation step, and test data can be used only for testing.

Further, signal data 101 comprising the at least one or more near-collision scenarios (e.g., near-collision scenarios unfamiliar to AI model 110) can form outlier data previously unseen by the first AI model (e.g., AI model 110), wherein the outlier data can be annotated (e.g., annotated either automatically or manually by a human expert) to generate annotated data for training the second AI model (e.g., AI model 220). The annotated data can be used as a new class of data to generate training data, validation data, and test data for training, validation and testing of the second AI model (e.g., AI model 220), wherein the annotated data can be stockpiled until a quantity of the annotated data exceeds a second defined threshold for the annotated data to be used as the new class of data for training the second AI model. For example, the annotated data can be stockpiled until enough data can be available to train AI model 220.

Thus, system 100 and/or components of system 100 can analyze signal data 101 such that AI model 220 can be trained to detect new classes of data previously unfamiliar to AI model 110. Further, system 100 and/or components of system 100 can analyze signal data 101 such that AI model 220 can be trained to detect new data within existing classes of data previously familiar to AI model 110, more accurately. One or more embodiments herein are described in greater detail with reference to FIGS. 2 and 3.

FIG. 2 illustrates a flow diagram of an example, non-limiting system 200 that enables training an AI model to detect new classes of conflict scenarios in accordance with one or more embodiments described herein. Repetitive description of like elements and/or processes employed in respective embodiments is omitted for sake of brevity.

In one or more embodiments, data collection component 112 can collect signal data (e.g., signal data 101 of FIG. 1) from a vehicle (e.g., vehicle 103 of FIG. 1). At 201, AI model 110 can process the signal data to detect one or more near-collision scenarios (e.g., braking upon suddenly detecting an animal). For example, at 201, AI model 110 can process the signal data to detect a familiar scenario such as a tree falling in front of the vehicle during a thunderstorm or to detect an unfamiliar scenario such as new type of road sign. Based on detection of a familiar near-collision scenario, AI model 110 can perform one or more actions based on prior training of AI model 110. For example, in the exemplary scenario of the tree discussed herein, AI model 110 can cause the vehicle to intervene upon detection of the tree to prevent the vehicle from a collision with the tree and/or other vehicles.

Further, unsupervised anomaly detector 202 can determine whether a classification of a scenario as a non-collision scenario, a near-collision scenario, etc. by AI model 110 is correct based on a familiarity of unsupervised anomaly detector 202 with the scenario. For example, in one or more embodiments, unsupervised anomaly detector 202 can process the signal data, at 201, to detect a near-collision scenario as opposed to a non-collision scenario detected by AI model 110 and communicated to unsupervised anomaly detector 202, at 207. Due to disagreement with the type of data detected by AI model 110, unsupervised anomaly detector 202 can classify the information as outlier data and generate an alert. That is, unsupervised anomaly detector 202 can detect an anomaly even when AI model 110 doesn't. The anomaly can be a new scenario that AI model 110 has not been trained on. Similarly, unsupervised anomaly detector 202 can process the signal data, at 201, to detect a non-collision scenario as opposed to the near-collision scenario detected by AI model 110 and communicated to unsupervised anomaly detector 202, at 207. Due to disagreement with the type of data detected by AI model 110, unsupervised anomaly detector 202 can classify the information as outlier data and generate an alert. That is, AI model 110 can communicate, at 207, information about the near-collision scenarios (e.g., irregular driving situations such as suddenly braking due to a pothole, braking due to bad road conditions, etc.), non-collision scenarios (e.g., non-near collision scenarios, etc.), and so on, to unsupervised anomaly detector 202 (e.g., detection component 108 of FIG. 1), and unsupervised anomaly detector 202 can classify the information as inlier data or outlier data.

Contrarily, unsupervised anomaly detector 202 and AI model 110 can process the signal data, at 201, to detect a non-collision scenario, and due to agreement upon the type of data detected by the AI model 110, unsupervised anomaly detector 202 can classify the information as inlier data. The non-collision scenarios that unsupervised anomaly detector 202 and AI model 110 agree upon can be discarded. Similarly, unsupervised anomaly detector 202 and AI model 110 can process the signal data, at 201, to detect a near-collision scenario, and due to agreement upon the type of data detected by AI model 110, unsupervised anomaly detector 202 can classify the information as inlier data.

Thus, unsupervised anomaly detector 202 can receive and process the signal data to generate a classification and compare the classification to a classification generated by AI model 110. When the classification generated by unsupervised anomaly detector 202 does not agree with the classification generated by AI model 110, the respective data can be collected as outlier data, and when the classification generated by unsupervised anomaly detector 202 agrees with the classification generated by AI model 110, the respective data can be collected as inlier data. Thus, signal data comprising one or more non-collision scenarios and/or one or more near-collision scenarios detected by AI model 110 during normal operations of a vehicle (e.g., vehicle 103 of FIG. 1) can be classified into inlier data and outlier data. Unsupervised anomaly detector 202 can have common data and anomaly as two classes, while the classifier (e.g., AI model 110) can have many classes (e.g., several different near-collision scenarios and one or more non-near-collision class). Thus, the classes of AI model 110 can require getting a label (e.g., “common” or “anomaly”) in order for unsupervised anomaly detector 202 to make a comparison. In one or more embodiments, unsupervised anomaly detector 202 can have access to “future data,” that is, unsupervised anomaly detector 202 can refer to a historical situation or event and determine whether the event was a near-collision event using data from after the event, whereas AI model 110 can only have access to data until the event, since AI model 110 can be required to be able to perform decisions on the fly. The role of unsupervised anomaly detector 202 can be to identify non-near collision events (e.g., non-collision scenarios) in order to discard the non-near collision events (e.g., discard the non-collision scenarios at 211 to samples 205) such that potential near-collision scenarios can remain as proposed training samples 204.

At 203, the signal data classified by unsupervised anomaly detector 202 as outlier data can be collected as proposed training samples 204, and, at 213, the signal data classified by unsupervised anomaly detector 202 as inlier data can be supplied to sample balancer 114. At 225, the outlier data from proposed training samples 204 and one or more classes of the inlier data required for training a new version of AI model 110 (e.g., AI model 220) can be sent to annotator 206 for manual annotation, wherein annotator 206 can be a human annotator. Sample balancer 114 can analyze the inlier data to identify the one or more classes of the inlier data to be sent to annotator 206 as reference data such that annotator 206 does not annotate only the outlier data (e.g., depending on capacity, samples can be stockpiled by sample balancer 114 until needed, or the samples can be discarded to samples 205).

At 215, annotator 206 can further classify the outlier data and the inlier data (e.g., one or more classes of inlier data) into new and existing classes of data respectively illustrated in FIG. 2 as new class of data 208 (e.g., ground truth classified samples of new class) and existing class of data 210 (e.g., labelled ground truth samples). Additionally, at 211, a portion of inlier data not required for training AI model 220 can be discarded to samples 205 because AI model 110, during normal operations, can collect several hours of inlier data which can comprise non-collision and near-collision scenarios familiar to AI model 110, not all of which can be required for training AI model 220. Further, it can be challenging to store hundreds of thousands of hours of data. Similarly, at 221, annotator 206 can further discard unnecessary data from the outlier data and the inlier data to samples 205. Once enough data can be collected as new class of data 208, annotated data (e.g., annotated data generated by annotator 206) from new class of data 208 can be used and thereby added to existing class of data 210, at 217, for training AI model 220. However, based on the addition of the test set, the addition can be reversed.

At 217 and 219, AI model 220 can be trained using the annotated data from new class of data 208 and existing class of data 210, and at 209, AI model 220 can be released as the new version of AI model 110 for the vehicle (e.g., vehicle 103 of FIG. 1). In one or more embodiments, AI model 220 can be allowed to shadow AI model 110 until performance of AI model 220 can be determined to be better than AI model 110 before replacing AI model 110 with AI model 220. Thus, AI model 110 can perform native functions of detecting one or more scenarios (e.g., non-collision scenarios, near-collision scenarios, collision scenarios) and taking appropriate actions based on prior training, and AI model 110 can simultaneously enhance a functionality of AI in the vehicle during ongoing data collection and/or deployment. It is to be appreciated that by executing functions such as, for example, causing emergency braking (e.g., during a near-collision scenario) based on prior training, AI model 110 can assist with eliminating some randomness from a process of classifying the signal data (e.g., non-collision scenarios, near-collision scenarios, collision scenarios) as inlier data or outlier data, since a log can be generated for the emergency braking. Further aspects of the flow diagram and system 200 discussed in FIG. 2 are disclosed with reference to FIG. 3.

FIG. 3 illustrates a flow diagram of an example, non-limiting system 300 that enables training an AI model to detect new classes of conflict scenarios in accordance with one or more embodiments described herein. Repetitive description of like elements and/or processes employed in respective embodiments is omitted for sake of brevity.

FIG. 3 illustrates information flows comprising a data flow of FIG. 2, in addition to a classification flow and an AI model flow. FIG. 3 further illustrates a legend for the respective information flows. As discussed in one or more embodiments, unsupervised anomaly detector 202 can receive and process signal data (e.g., signal data 101 of FIG. 1) from a vehicle (e.g., vehicle 103 of FIG. 1) to generate a classification (e.g., non-collision scenarios, near-collision scenarios, etc.) and compare the classification to a classification generated by AI model 110 (e.g., non-collision scenarios, near-collision scenarios, etc.) and communicated to unsupervised anomaly detector 202 at 302. When the classification generated by unsupervised anomaly detector 202 does not agree with the classification generated by AI model 110, the respective data can be collected as outlier data at 203, and when the classification generated by unsupervised anomaly detector 202 agrees with the classification generated by AI model 110, the respective data can be collected as inlier data at 213. A general flow of data within system 300 can be illustrated by the solid lined arrows.

The signal data (e.g., respective scenarios comprising the signal data) classified as outlier data by unsupervised anomaly detector 202 can be sent to proposed training samples 204, and the signal data classified as inlier data by unsupervised anomaly detector 202 can be sent to sample balancer 114 (e.g., at 213, at 316). Even though the inlier data can comprise a classification of data (e.g., non-collision scenarios, near-collision scenarios, etc.) that unsupervised anomaly detector 202 and AI model 110 agree upon, the inlier data can be required to be manually annotated by annotator 206 (e.g., user, human annotator) for potential corrections to the classification of inlier data. An outcome of manual annotation by annotator 206 can result in a new classification for the inlier data (e.g., at 308). Similarly, as discussed in one or more embodiments, the outlier data can be further annotated by annotator 206 for potential corrections and generating a new classification (e.g., at 308). Annotator 206 can be an expert annotator and annotator 206 can further classify the inlier data and the outlier data into new class of data 208 and existing class of data 210. Further, sample balancer 114 and annotator 206 can respectively discard unnecessary samples of data received by sample balancer 114 and annotator 206 at 304 and at 306. The samples of data discarded by sample balancer 114 and annotator 206 can collectively form samples 205.

New class of data 208 can comprise one or more scenarios unfamiliar to AI model 110. For example, new class of data 208 can comprise a new road sign that AI model 110 can have no prior training on. For example, new class of data 208 can comprise a new type of crossing or a new type of road that a vehicle (e.g., vehicle 103 of FIG. 1) associated with AI model 110 can be driving on, such that the new type of crossing or the new type of road can cause AI model 110 to perform poorly due to lack of training in detecting and/or responding to the new type of crossing or the new type of road. For example, new class of data 208 can comprise a situation further comprising a series of happenings or a series of consecutive events, such as a specific type of road sign combined with presence of a moose, deer, or another animal, that can be required to be captured. For example, new class of data 208 can comprise an object that is neither a car nor a pedestrian. For example, new class of data 208 can comprise a vehicle that can appear different from normal vehicles, such as a hot dog van looking like a hot dog. Thus, new class of data 208 can comprise data required for improving performance of an AI model on categories or situations unfamiliar to the AI model.

Existing class of data 210 can comprise one or more scenarios familiar to AI model 110. For example, existing class of data 210 can comprise data related to scenarios (e.g., non-collision scenarios, near-collision scenarios, etc.) involving red cars. For example, AI model 110 can require more training in detecting red cars or in detecting near-collision scenarios involving red cars (i.e., overbalancing of red cars can be required), even if AI model 110 can comprise prior training in detecting red cars. Thus, red cars or scenarios involving red cars can be classified as existing class of data 210. For example, existing class of data 210 can comprise scenarios involving moose sightings in sunlight, wherein AI model 110 can comprise prior training in detecting moose and sunlight individually, but wherein AI model 110 can require more training in detecting moose in sunlight to prevent a collision. Thus, existing class of data 210 can comprise data required for improving performance of an AI model on categories or situations familiar to the AI model.

While AI model 220 (e.g., a new version of an existing AI model) can be trained based on outlier data to include new classes of data, at least 50 percent (50%) of training data for AI model 220 can be inlier data to prevent AI model 220 from identifying inlier data as outlier data in subsequent deployments. Thus, it can be necessary to collect the inlier data for enhancing performance of AI model 220 in one or more specific categories (e.g., scenarios involving red cars) familiar to AI model 110 (e.g., the existing AI model). While the inlier data can belong to various categories, sample balancer 114 can analyze the inlier data to identify the one or more specific categories of data required for training AI model 220. As described herein, in FIG. 3, the solid lined arrows can illustrate the general flow of data within system 300 and the dashed (smaller dashes) arrows can indicate a classification on the data (e.g., with classification labels).

As discussed in one or more embodiments, the annotated data from manual annotation of the outlier data and the one or more categories of the inlier data can be divided into respective training, validation, and test data sets for new class of data 208 and existing class of data 210. AI model 220 can be trained at 310 and 312 using the respective training, validation, and test data sets from new class of data 208 and existing class of data 210. It is to be appreciated that training AI model 220 can comprise additional steps such as various training steps, validation steps, etc. not shown in FIG. 3. Data from new class of data 208 can be stockpiled to ensure that there is enough data available in new class of data 208 before being utilized to train AI model 220. Stockpiling can also ensure that certain scenarios or categories of data are occurring often enough.

At 314, AI model 220 can be released as a new version of AI model 110 or AI model 220 can be allowed to shadow AI model 110 before being released as the new version of AI model 110. Thus, AI model 220 can be trained to detect one or more new near-collision scenarios (e.g., near-collision scenarios 115 of FIG. 1) more accurately than AI model 110. For example, AI model 220 can detect a new type of road sign or AI model 220 can detect red cars more accurately than AI model 110 to prevent a collision. It is to be further appreciated that training AI model 220 can be a form of centralized learning, for example, to update a software version associated with AI model 110 by deploying AI model 220 in multiple vehicles after validation. In an embodiment, training AI model 220 can potentially be a form of individual learning for a singular vehicle. While cars need not be required to evolve individually too much, some adaptation can be needed in special cases.

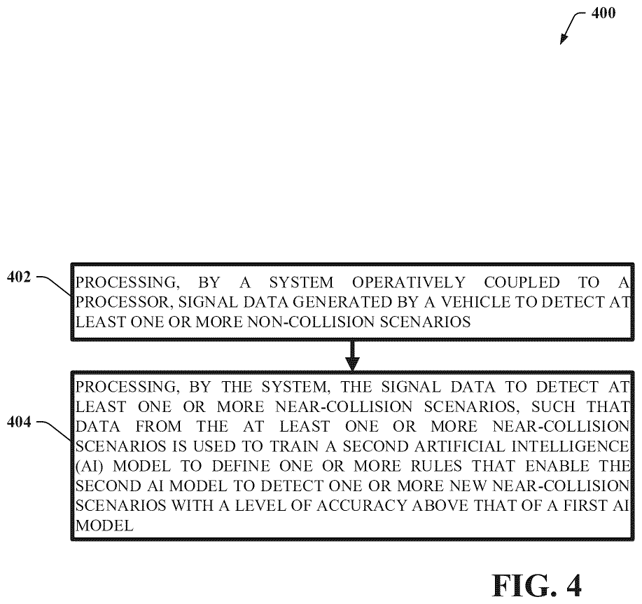

FIG. 4 illustrates a flow diagram of an example, non-limiting method 400 that enables an AI model to detect new and existing classes of conflict scenarios for vehicles in accordance with one or more embodiments described herein. Repetitive description of like elements and/or processes employed in respective embodiments is omitted for sake of brevity.

At 402, the non-limiting method 400 can comprise processing (e.g., by detection component 108), by a system operatively coupled to a processor (e.g., system 100, system 200, system 300), signal data generated by a vehicle to detect at least one or more non-collision scenarios.

At 404, the non-limiting method 400 can comprise processing (e.g., by AI model 110), by the system, the signal data to detect at least one or more near-collision scenarios, such that data from the at least one or more near-collision scenarios is used to train a second AI model to define one or more rules that enable the second AI model to detect one or more new near-collision scenarios with a level of accuracy above that of a first AI model.

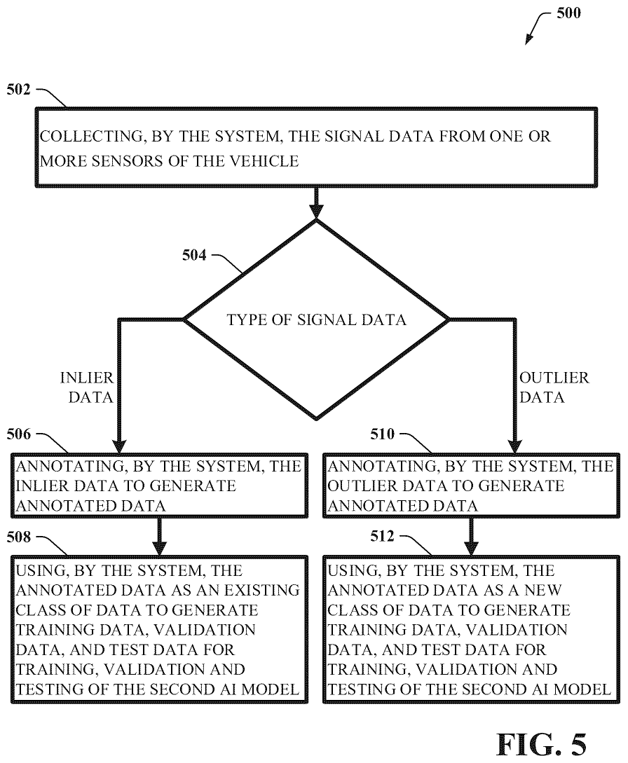

Further aspects of non-limiting method 400 are disclosed with reference to FIG. 5.

FIG. 5 illustrates a flow diagram of an example, non-limiting method 500 that enables training an AI model to detect new classes of conflict scenarios for vehicles in accordance with one or more embodiments described herein. Repetitive description of like elements and/or processes employed in respective embodiments is omitted for sake of brevity.

At 502, the non-limiting method 500 can comprise collecting (e.g., by data collection component 112), by the system (e.g., system 100, system 200, system 300), the signal data from one or more sensors of the vehicle. It is to be appreciated that, at 502, the signal data can be collected from one or more sensors of the vehicle or from other data sources. For example, some data useful for classification can come from sources other than vehicle sensors (e.g. road map information, weather data, etc.).

At 504, the non-limiting method 500 can determine (e.g., by detection component 108, AI model 110) the type of signal data.

When the signal data comprises inlier data, the non-limiting method 500 can comprise, at 506, annotating (e.g., by a human annotator), the inlier data to generate annotated data. Further, the non-limiting method 500 can comprise, at 508, using, by the system, the annotated data as an existing class of data to generate training data, validation data, and test data for training, validation and testing of the second AI model.

When the signal data comprises outlier data, the non-limiting method 500 can comprise, at 510, annotating (e.g., by a human annotator), the outlier data to generate annotated data. Further, the non-limiting method 500 can comprise, at 512, using, by the system, the annotated data as a new class of data to generate training data, validation data, and test data for training, validation and testing of the second AI model.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively improve an ability of an AI model to detect risk/near-collision scenarios from a vehicle's signal data, enable the AI model to define more accurate rules to detect the risk/near-collision scenarios, and/or enable the AI model to propose new risk/near-collision scenarios during ongoing data collection and/or deployment as the one or more embodiments described herein can enable this process. And, neither can the human mind nor a human with pen and paper improve an ability of an AI model to detect risk/near-collision scenarios from a vehicle's signal data, enable the AI model to define more accurate rules to detect the risk/near-collision scenarios, and/or enable the AI model to propose new risk/near-collision scenarios during ongoing data collection and/or deployment, as conducted by one or more embodiments described herein.

Turning next to FIGS. 6 and 7, a detailed description is provided of additional context for the one or more embodiments described herein with FIGS. 1-5.

In order to provide a context for the various aspects of the disclosed subject matter, FIG. 6 as well as the following discussion are intended to provide a general description of a suitable environment in which the various aspects of the disclosed subject matter can be implemented. FIG. 6 illustrates a block diagram of an example, non-limiting operating environment in which one or more embodiments described herein can be facilitated. Repetitive description of like elements employed in other embodiments described herein is omitted for sake of brevity. With reference to FIG. 6, a suitable operating environment 600 for implementing various aspects of this disclosure can also include a computer 612. The computer 612 can also include a processing unit 614, a system memory 616, and a system bus 618. The system bus 618 couples system components including, but not limited to, the system memory 616 to the processing unit 614. The processing unit 614 can be any of various available processors. Dual microprocessors and other multiprocessor architectures also can be employed as the processing unit 614. The system bus 618 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), Small Computer Systems Interface (SCSI), a controller area network (CAN) bus, and a local interconnect network (LIN) bus. The system memory 616 can also include volatile memory 620 and nonvolatile memory 622. The basic input/output system (BIOS), containing the basic routines to transfer information between elements within the computer 612, such as during start-up, is stored in nonvolatile memory 622. By way of illustration, and not limitation, nonvolatile memory 622 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 620 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 612 can also include removable/non-removable, volatile/non-volatile computer storage media. FIG. 6 illustrates, for example, a disk storage 624. Disk storage 624 can also include, but is not limited to, devices like a magnetic disk drive, floppy disk drive, tape drive, Jaz drive, Zip drive, LS-100 drive, flash memory card, or memory stick. The disk storage 624 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 624 to the system bus 618, a removable or non-removable interface is typically used, such as interface 626. FIG. 6 also depicts software that acts as an intermediary between users and the basic computer resources described in the suitable operating environment 600. Such software can also include, for example, an operating system 628. Operating system 628, which can be stored on disk storage 624, acts to control and allocate resources of the computer 612. System applications 630 take advantage of the management of resources by operating system 628 through program modules 632 and program data 634, e.g., stored either in system memory 616 or on disk storage 624. It is to be appreciated that this disclosure can be implemented with various operating systems or combinations of operating systems. A user enters commands or information into the computer 612 through input device(s) 636. Input devices 636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 614 through the system bus 618 via interface port(s) 638. Interface port(s) 638 include, for example, a serial port, a parallel port, a game port, and a universal serial bus (USB). Output device(s) 640 use some of the same type of ports as input device(s) 636. Thus, for example, a USB port can be used to provide input to computer 612, and to output information from computer 612 to an output device 640. Output adapter 642 is provided to illustrate that there are some output devices 640 like monitors, speakers, and printers, among other output devices 640, which require special adapters. The output adapters 642 include, by way of illustration and not limitation, video and sound cards that provide a means of connection between the output device 640 and the system bus 618. It should be noted that other devices and/or systems of devices provide both input and output capabilities such as remote computer(s) 644.

Computer 612 can operate in a networked environment using logical connections to one or more remote computers, such as remote computer(s) 644. The remote computer(s) 644 can be a computer, a server, a router, a network PC, a workstation, a microprocessor based appliance, a peer device or other common network node and the like, and typically can also include many or all of the elements described relative to computer 612. For purposes of brevity, only a memory storage device 646 is illustrated with remote computer(s) 644. Remote computer(s) 644 is logically connected to computer 612 through a network interface 648 and then physically connected via communication connection 650. Network interface 648 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 650 refers to the hardware/software employed to connect the network interface 648 to the system bus 618. While communication connection 650 is shown for illustrative clarity inside computer 612, it can also be external to computer 612. The hardware/software for connection to the network interface 648 can also include, for example purposes only, internal and external technologies such as, modems including regular telephone grade modems, cable modems and DSL modems, ISDN adapters, and Ethernet cards.

The illustrated embodiments described herein can be employed relative to distributed computing environments (e.g., cloud computing environments), such as described below with respect to FIG. 7, where certain tasks are performed by remote processing devices that are linked through a communications network. In a distributed computing environment, program modules can be located both in local and/or remote memory storage devices.

For example, one or more embodiments described herein and/or one or more components thereof can employ one or more computing resources of the cloud computing environment described below with reference to illustration 700 of FIG. 7. For instance, one or more embodiments described herein and/or components thereof can employ such one or more resources to execute one or more: mathematical function, calculation and/or equation; computing and/or processing script; algorithm; model (e.g., artificial intelligence (AI) model, machine learning (ML) model, deep learning (DL) model, and/or like model); and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed. That is, the one or more embodiments described herein can be implemented in a local environment only, and/or a non-cloud-integrated distributed environment, for example.

A cloud computing environment can provide one or more of low coupling, modularity and/or semantic interoperability. At the heart of cloud computing is an infrastructure that includes a network of interconnected aspects.

Moreover, the non-limiting systems 100-500 can be associated with and/or be included in cloud-based and/or partially-cloud-based system.

Referring now to details of one or more elements illustrated at FIG. 7, an illustrative cloud computing environment 700 is depicted. FIG. 7 is a schematic block diagram of a computing environment 700 with which the disclosed subject matter can interact. The system 700 comprises one or more remote component(s) 710. The remote component(s) 710 can be hardware and/or software (e.g., threads, processes, computing devices). In some embodiments, remote component(s) 710 can be a distributed computer system, connected to a local automatic scaling component and/or programs that use the resources of a distributed computer system, via communication framework 740. Communication framework 740 can comprise wired network devices, wireless network devices, mobile devices, wearable devices, radio access network devices, gateway devices, femtocell devices, servers, etc.

The system 700 also comprises one or more local component(s) 720. The local component(s) 720 can be hardware and/or software (e.g., threads, processes, computing devices). In some embodiments, local component(s) 720 can comprise an automatic scaling component and/or programs that communicate/use the remote resources 710 and 720, etc., connected to a remotely located distributed computing system via communication framework 740.

One possible communication between a remote component(s) 710 and a local component(s) 720 can be in the form of a data packet adapted to be transmitted between two or more computer processes. Another possible communication between a remote component(s) 710 and a local component(s) 720 can be in the form of circuit-switched data adapted to be transmitted between two or more computer processes in radio time slots. The system 700 comprises a communication framework 740 that can be employed to facilitate communications between the remote component(s) 710 and the local component(s) 720, and can comprise an air interface, e.g., Uu interface of a UMTS network, via a long-term evolution (LTE) network, etc. Remote component(s) 710 can be operably connected to one or more remote data store(s) 750, such as a hard drive, solid state drive, SIM card, device memory, etc., that can be employed to store information on the remote component(s) 710 side of communication framework 740. Similarly, local component(s) 720 can be operably connected to one or more local data store(s) 730, that can be employed to store information on the local component(s) 720 side of communication framework 740.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures, and/or the like that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes”, “has”, “possesses”, and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

Further aspects of various embodiments described herein are provided by the subject matter of the following clauses:
1. A computer-implemented system, comprising:
a memory that stores computer executable components; and
a processor that executes the computer executable components stored in the memory, wherein the computer executable components comprise:
a detection component that processes signal data generated by a vehicle to detect at least one or more non-collision scenarios; and
a first AI model that processes the signal data to detect at least one or more near-collision scenarios, such that data from the at least one or more near-collision scenarios is used to train a second AI model to define one or more rules that enable the second AI model to detect one or more new near-collision scenarios with a level of accuracy above that of the first AI model.
2. The computer-implemented system of any preceding clause, further comprising:
a data collection component that collects the signal data from one or more sensors of the vehicle.
3. The computer-implemented system of any preceding clause, wherein the signal data comprising the at least one or more near-collision scenarios forms inlier data required for training the second AI model.
4. The computer-implemented system of any preceding clause, further comprising:
a sample balancer that analyzes the inlier data to identify, from the inlier data, one or more classes of data required for the training of the second AI model, wherein the one or more classes of data are annotated to generate annotated data for the training of the second AI model.
5. The computer-implemented system of any preceding clause, wherein the annotated data is used as an existing class of data to generate training data, validation data, and test data for the training, validation and testing of the second AI model.
6. The computer-implemented system of any preceding clause, wherein the signal data comprising the at least one or more near-collision scenarios forms outlier data previously unseen by the first AI model, wherein the outlier data is annotated to generate annotated data for training of the second AI model.
7. The computer-implemented system of any preceding clause, wherein the annotated data is used as a new class of data to generate training data, validation data, and test data for the training, validation and testing of the second AI model.
8. The computer-implemented system of any preceding clause, wherein the annotated data is stockpiled until a quantity of the annotated data exceeds a defined threshold for the annotated data to be used as the new class of data.
9. The computer-implemented system of any preceding clause, wherein the second AI model combines two or more signals from the signal data to define the one or more rules.
10. The computer-implemented system of clause 1 above with any set of combinations of computer-implemented systems 2-9 above.
11. A computer-implemented method, comprising:
processing, by a system operatively coupled to a processor, signal data generated by a vehicle to detect at least one or more non-collision scenarios; and
processing, by the system, the signal data to detect at least one or more near-collision scenarios, such that data from the at least one or more near-collision scenarios is used to train a second AI model to define one or more rules that enable the second AI model to detect one or more new near-collision scenarios with a level of accuracy above that of a first AI model.
12. The computer-implemented method of any preceding clause, further comprising:
collecting, by the system, the signal data from one or more sensors of the vehicle, wherein the signal data comprising the at least one or more near-collision scenarios forms inlier data required for training the second AI model.
13. The computer-implemented method of any preceding clause, further comprising:
analyzing, by the system, the inlier data to identify, from the inlier data, one or more classes of data required for the training of the second AI model, wherein the one or more classes of data are annotated to generate annotated data for the training of the second AI model.
14. The computer-implemented method of any preceding clause, further comprising:
using, by the system, the annotated data as an existing class of data to generate training data, validation data, and test data for the training, validation and testing of the second AI model.
15. The computer-implemented method of any preceding clause, wherein the signal data comprising the at least one or more near-collision scenarios forms outlier data previously unseen by the first AI model, wherein the outlier data is annotated to generate annotated data for training of the second AI model.
16. The computer-implemented method of any preceding clause, further comprising:
using, by the system, the annotated data as a new class of data to generate training data, validation data, and test data for the training, validation and testing of the second AI model.
17. The computer-implemented method of any preceding clause, further comprising:
stockpiling, by the system, the annotated data until a quantity of the annotated data exceeds a second defined threshold for the annotated data to be used as the new class of data.
18. The computer-implemented method of any preceding clause, wherein the second AI model combines two or more signals from the signal data to define the one or more rules.
19. The computer-implemented method of clause 11 above with any set of combinations of computer-implemented methods 12-18 above.
20. A computer program product for using an AI model to detect conflict scenarios for vehicles, the computer program product comprising a computer readable storage medium having program instructions embodied therewith, the program instructions executable by a processor to cause the processor to:
process, by the processor, signal data generated by a vehicle to detect at least one or more non-collision scenarios; and
process, by the processor, the signal data to detect at least one or more near-collision scenarios, such that data from the at least one or more near-collision scenarios is used to train a second AI model to define one or more rules that enable the second AI model to detect one or more new near-collision scenarios with a level of accuracy above that of a first AI model.
21. The computer program product of any preceding clause, wherein the program instructions are further executable by the processor to cause the processor to:
collect, by the processor, the signal data from one or more sensors of the vehicle, wherein the signal data comprising the at least one or more near-collision scenarios forms inlier data required for training the second AI model.
22. The computer program product of any preceding clause, wherein the program instructions are further executable by the processor to cause the processor to:
analyze, by the processor, the inlier data to identify, from the inlier data, one or more classes of data required for the training of the second AI model, wherein the one or more classes of data are annotated to generate annotated data for the training of the second AI model.
23. The computer program product of clause 20 above with any set of combinations of computer program products 21 and 22 above.

What is claimed is:

1. A computer-implemented system, comprising:
a memory that stores computer executable components; and
a processor that executes the computer executable components stored in the memory, wherein the computer executable components comprise:
a detection component that processes signal data generated by a vehicle to detect at least one or more non-collision scenarios; and
a first artificial intelligence (AI) model that processes the signal data to detect at least one or more near-collision scenarios, such that data from the at least one or more near-collision scenarios is used to train a second AI model to define one or more rules that enable the second AI model to detect one or more new near-collision scenarios with a level of accuracy above that of the first AI model.

2. The computer-implemented system of claim 1, further comprising:
a data collection component that collects the signal data from one or more sensors of the vehicle.

3. The computer-implemented system of claim 1, wherein the signal data comprising the at least one or more near-collision scenarios forms inlier data required for training the second AI model.

4. The computer-implemented system of claim 3, further comprising:
a sample balancer that analyzes the inlier data to identify, from the inlier data, one or more classes of data required for the training of the second AI model, wherein the one or more classes of data are annotated to generate annotated data for the training of the second AI model.

5. The computer-implemented system of claim 4, wherein the annotated data is used as an existing class of data to generate training data, validation data, and test data for the training, validation and testing of the second AI model.

6. The computer-implemented system of claim 1, wherein the signal data comprising the at least one or more near-collision scenarios forms outlier data previously unseen by the first AI model, wherein the outlier data is annotated to generate annotated data for training of the second AI model.

7. The computer-implemented system of claim 6, wherein the annotated data is used as a new class of data to generate training data, validation data, and test data for the training, validation and testing of the second AI model.

8. The computer-implemented system of claim 7, wherein the annotated data is stockpiled until a quantity of the annotated data exceeds a defined threshold for the annotated data to be used as the new class of data.

9. The computer-implemented system of claim 1, wherein the second AI model combines two or more signals from the signal data to define the one or more rules.

10. A computer-implemented method, comprising:
processing, by a system operatively coupled to a processor, signal data generated by a vehicle to detect at least one or more non-collision scenarios; and
processing, by the system, the signal data to detect at least one or more near-collision scenarios, such that data from the at least one or more near-collision scenarios is used to train a second AI model to define one or more rules that enable the second AI model to detect one or more new near-collision scenarios with a level of accuracy above that of a first AI model.

11. The computer-implemented method of claim 10, further comprising:
collecting, by the system, the signal data from one or more sensors of the vehicle, wherein the signal data comprising the at least one or more near-collision scenarios forms inlier data required for training the second AI model.

12. The computer-implemented method of claim 11, further comprising:
analyzing, by the system, the inlier data to identify, from the inlier data, one or more classes of data required for the training of the second AI model, wherein the one or more classes of data are annotated to generate annotated data for the training of the second AI model.

13. The computer-implemented method of claim 12, further comprising:
using, by the system, the annotated data as an existing class of data to generate training data, validation data, and test data for the training, validation and testing of the second AI model.

14. The computer-implemented method of claim 10, wherein the signal data comprising the at least one or more near-collision scenarios forms outlier data previously unseen by the first AI model, wherein the outlier data is annotated to generate annotated data for training of the second AI model.

15. The computer-implemented method of claim 14, further comprising:
using, by the system, the annotated data as a new class of data to generate training data, validation data, and test data for the training, validation and testing of the second AI model.

16. The computer-implemented method of claim 15, further comprising:
stockpiling, by the system, the annotated data until a quantity of the annotated data exceeds a second defined threshold for the annotated data to be used as the new class of data.

17. The computer-implemented method of claim 10, wherein the second AI model combines two or more signals from the signal data to define the one or more rules.

18. A computer program product for using an AI model to detect conflict scenarios for vehicles, the computer program product comprising a computer readable storage medium having program instructions embodied therewith, the program instructions executable by a processor to cause the processor to:
process, by the processor, signal data generated by a vehicle to detect at least one or more non-collision scenarios; and
process, by the processor, the signal data to detect at least one or more near-collision scenarios, such that data from the at least one or more near-collision scenarios is used to train a second AI model to define one or more rules that enable the second AI model to detect one or more new near-collision scenarios with a level of accuracy above that of a first AI model.

19. The computer program product of claim 18, wherein the program instructions are further executable by the processor to cause the processor to:
collect, by the processor, the signal data from one or more sensors of the vehicle, wherein the signal data comprising the at least one or more near-collision scenarios forms inlier data required for training the second AI model.

20. The computer program product of claim 19, wherein the program instructions are further executable by the processor to cause the processor to:
analyze, by the processor, the inlier data to identify, from the inlier data, one or more classes of data required for the training of the second AI model, wherein the one or more classes of data are annotated to generate annotated data for the training of the second AI model.
